(19) United States
(12) Patent Application Publication
(10) Pub. No.: US 2009/0255304 A1
(43) Pub. Date: Oct. 15, 2009

(54) Key storage casing having key recognition function

(76) Inventor: Ki Dong Kim, Seoul (KR)

Correspondence Address: ROBERT E. BUSHNELL & LAW FIRM, 2029 K STREET NW, SUITE 600, WASHINGTON, DC, 20006-1004, US

(21) Appl. No.: 12/153,265

(22) Filed: May 15, 2008

(30) Foreign Application Priority Data
Apr. 15, 2008 (KR) 10-2008-0034652

(51) Int. Cl. E05B 19/24

(52) U.S. Cl. 70/460

(57) ABSTRACT

A key storage casing having a key recognition function is disclosed, which includes an insertion unit having a certain specific impedance value for receiving a key therein, at least two key insertion arrangement units, an impedance recognition unit for recognizing whether the key inserted into the key insertion arrangement unit is a corresponding key with the help of an impedance value, and a display unit which displays a key return/discharge/storage information. So, it is possible to reliably store and check the state of a discharge/return/storage of a corresponding key. A data communication unit is provided for transmitting a data concerning a discharge/return/storage to an external terminal for thereby reliably managing a data concerning a discharge/return/storage of a key.

### CLAIM OF PRIORITY

This application makes reference to, incorporates the same herein, and claims all benefits accruing under 35 U.S.C. §119 from an application for KEY STORAGE CASE earlier filed in the Korean Intellectual Property Office on 15 Apr. 2008 and there duly assigned Serial No. 10-2008-0034652.

### TECHNICAL FIELD

The present invention relates to a key storage casing having a key recognition function, and in particular to a key storage casing having a key recognition function which includes an insertion unit having a certain specific impedance value for receiving a key therein, at least two key insertion arrangement units, an impedance recognition unit for recognizing whether the key inserted into the key insertion arrangement unit is a corresponding key with the help of an impedance value, and a display unit which displays a key return/discharge/storage information. So, it is possible to reliably store and check the state of a discharge/return/storage of a corresponding key. A data communication unit is provided for transmitting a data concerning a discharge/return/storage to an external terminal for thereby reliably managing a data concerning a discharge/return/storage of a key.

### BACKGROUND ART

Generally, a key storage casing is constructed to prevent multiple keys from being lost and is widely used in a parking management facility, a hotel, a complex building, a bank and an office.

The conventional key storage casing is provided with a key insertion arrangement unit formed of a hanging unit for hanging keys in the interior of the casing. In the conventional key storage casing, it is impossible to check whether a corresponding key is hanged in a key hanging unit like a key hanger, so that a security problem and a non-efficient management problem occur.

The Korean patent number 0437941 discloses a key recognition unit in a key insertion arrangement unit like a key hanger, so it is possible to check whether a corresponding key is hanged in a key hanger.

However, a conventional key storage casing is not provided with a key recognition function, so it is impossible to check whether a corresponding key is hanged in a key hanger when storing a key by hanging the same on a key hanger. So, the conventional key storage casing has many problems in use when there are multiple key management persons or users, so a key return/discharge/storage management is not properly achieved in the conventional art.

### DISCLOSURE OF THE INVENTION

Accordingly, it is an object of the present invention to provide a key storage casing which overcomes the problems that it is impossible to check whether a corresponding key is hanged in a key hanging unit or not when checking the stored state of keys.

To achieve the above objects, there is provided a key storage casing which includes an insertion unit having a certain specific impedance value for receiving a key therein, at least two key insertion arrangement units, an impedance recognition unit for recognizing whether the key inserted into the key insertion arrangement unit is a corresponding key with the help of an impedance value, and a display unit which displays a key return/discharge/storage information.

### EFFECTS OF THE INVENTION

In the present invention, at least two key insertion arrangement units are provided in a key storage casing, and an insertion unit is provided in a key, and there is provided an impedance recognition unit for recognizing whether a key inserted into the key insertion arrangement unit is a corresponding key or not, so a corresponding is always inserted in place when storing and managing the keys, and it is possible to effectively manage when keys are discharged or stored, so a key management is reliable and easy.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings in which like reference symbols indicate the same or similar components, wherein:

FIG. 1 is a perspective view illustrating a key storage casing having a key recognition function according to the present invention;

FIG. 2 is a detailed perspective view illustrating a key storage casing having a key recognition function according to the present invention;

FIG. 3 is a view illustrating the important elements of a key storage casing having a key recognition function according to the present invention;

FIG. 4 is a perspective view illustrating a construction that a display unit is formed of a key recognition light according to the present invention;

FIG. 5 is a perspective view illustrating a construction that a display unit is formed of a display device according to the present invention;

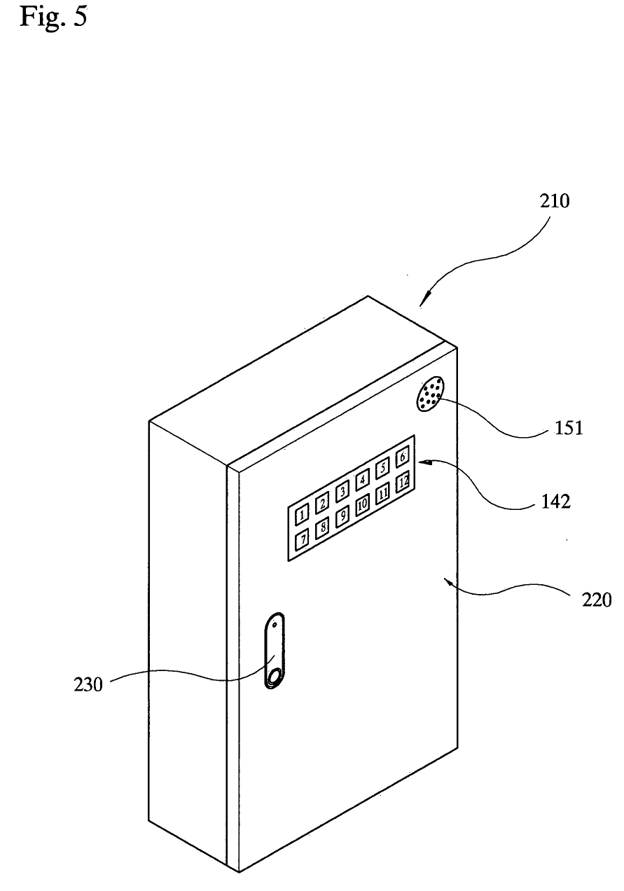

FIG. 6 is a perspective view illustrating a construction that a user input unit is formed of a user input member according to the present invention;

FIG. 7 is a perspective view illustrating a construction that a user input unit is formed of a user card reader unit according to the present invention; and

FIG. 8 is a perspective view illustrating a data communication unit according to the present invention.

### MODES FOR CARRYING OUT THE INVENTION

The preferred embodiments of the present invention will be described with reference to the accompanying drawings.

In the present invention, when storing keys, it is possible to reliably store a corresponding key in place and to check the same.

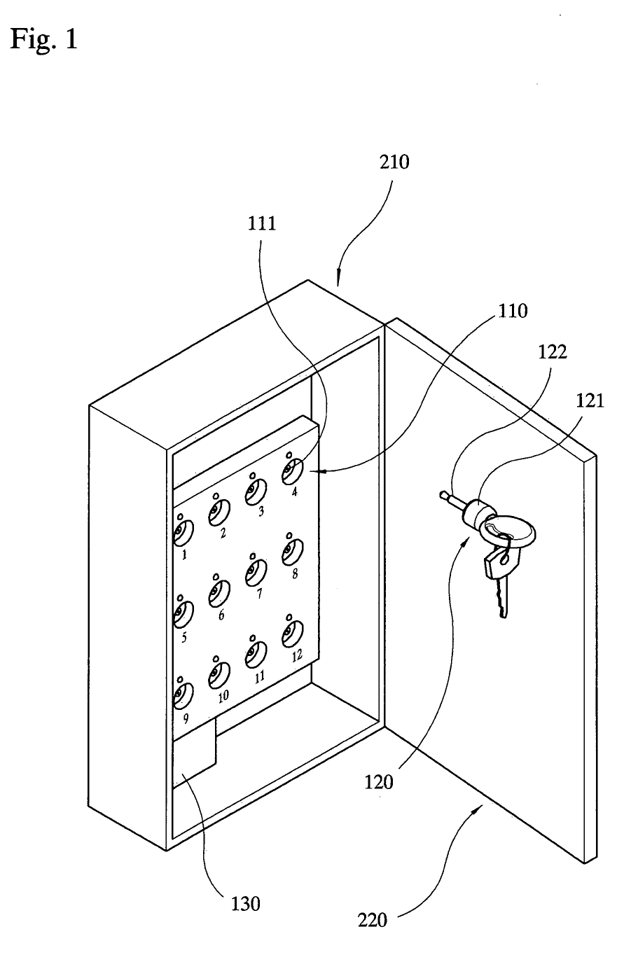

As shown in FIG. 1, in a key storage casing formed of a storage casing 210 for storing and arranging keys in the same, there is provided a key storage casing having a key recognition function which comprises at least two key insertion arrangement units 110 provided in the storage casing 210 with an insertion member 120 being provided in the key; and an impedance recognition unit which is constructed to recognize whether a key inserted into and arranged in the key insertion arrangement unit 110 is a corresponding key or not.

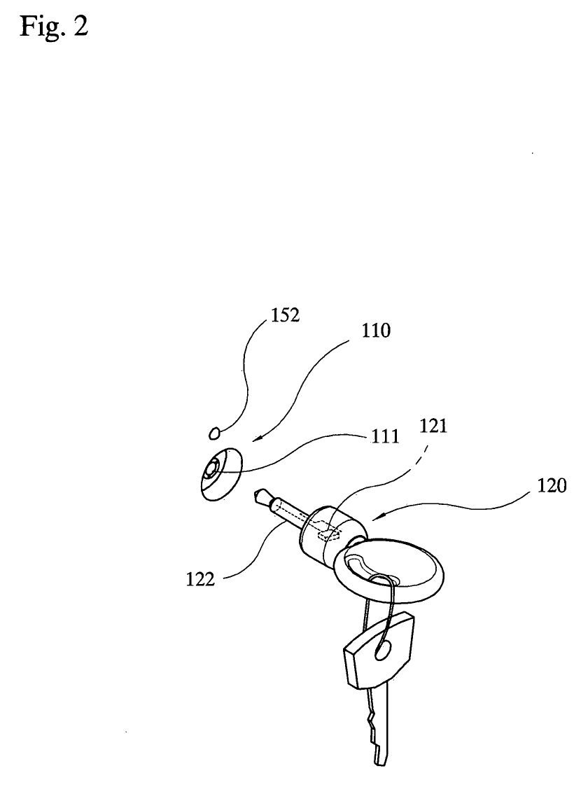

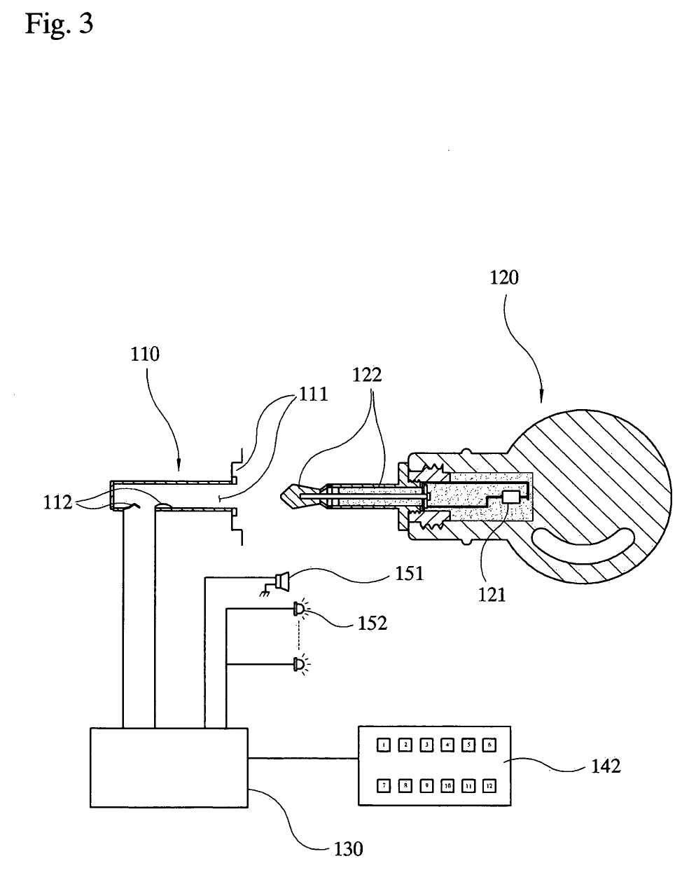

As shown in FIGS. 2 and 3, the key insertion arrangement unit 110 is provided with a key insertion hole 111 for inserting and arranging the insertion unit 120, and the insertion unit 120 may be provided in a key holder which is conventionally provided in a key.

As shown in FIGS. 2 and 3, the impedance recognition unit 110 includes impedance member 121 having different impedances for recognizing keys in each insertion unit 120, an impedance connection unit 122 which has an insertion and arrangement function in the insertion unit 120 and has a connection unit connected with the impedance body 121, an impedance connection unit 112 which connects with the impedance member 121 provided in the insertion unit 120 through the impedance connection unit 122 in the key insertion arrangement unit 110, a controller 130 which reads an impedance value of a key inserted into the key insertion and arrangement unit 110 by reading each impedance connection unit 112 and recognizes whether a corresponding key is inserted or not, and a display unit for displaying an arranged state of the key.

The impedance body 121 is formed of at least one impedance member among a resistor, a condenser and a coil.

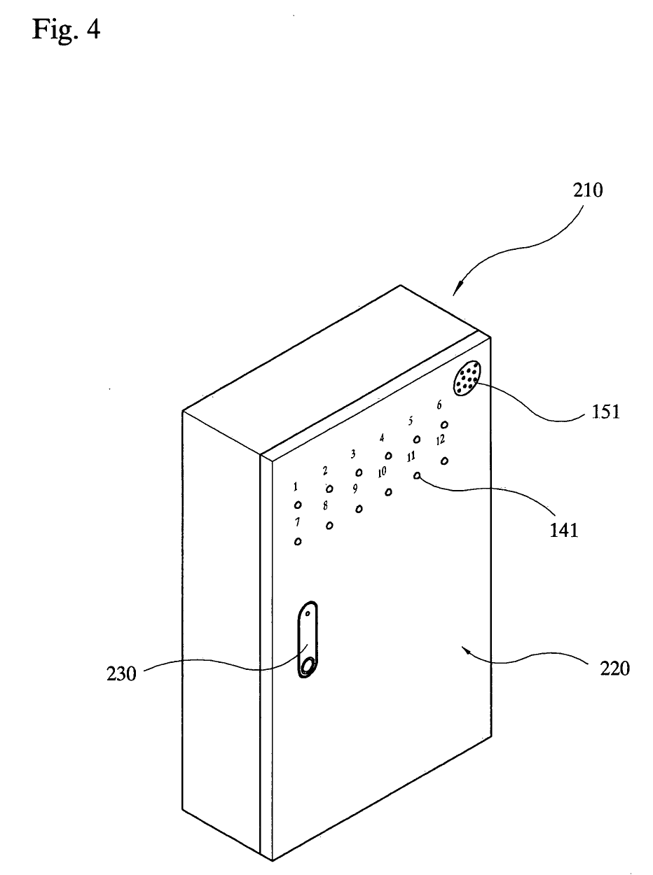

As shown in FIG. 4, the display unit is selectively formed of either a key recognition light 141 or a display unit 142 for displaying a key arrangement state in a digital form, which is disposed at one side of the storage casing 210 or in a door 220 provided for opening and closing the storage casing 210.

As shown in FIGS. 1 and 2, a voice guide member 151 may be provided for informing a state that a wrong key is inserted into the key insertion arrangement unit 110 in a sound form, and an arrangement confirmation lamp 152 may be provided at one side of each key insertion arrangement unit 110 for informing a key arranged state in a light flashing form.

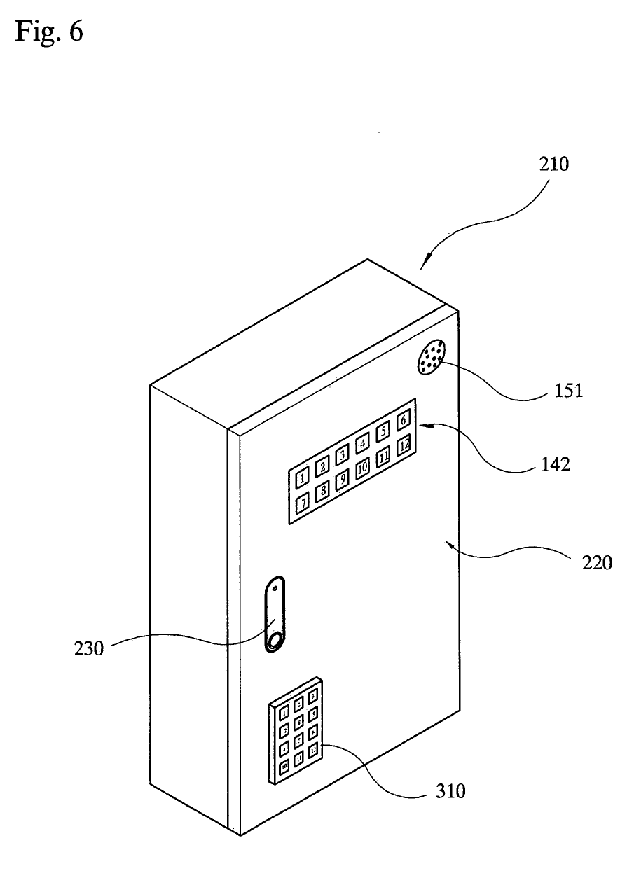

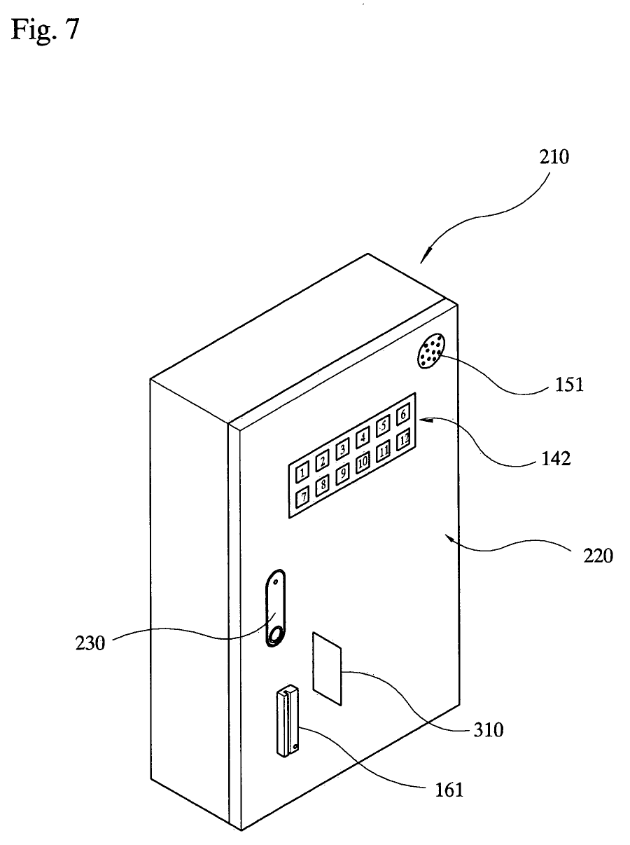

As shown in FIGS. 6 and 7, a locking apparatus 230 is provided in a door 220, which is adapted for opening and closing the storage casing, the locking apparatus 230 being constructed to perform a locking function in accordance with an operation of the controller 130, and a user confirmation unit is provided for controlling an operation of the locking apparatus 230 as the controller 130 recognizes a user who discharge the key and a user who returns the key, and a user data unit 131 is provided for storing a key return/discharge information by a user checked through the user confirmation unit.

As shown in FIG. 6, the user confirmation unit is selectively formed of either a user input unit 161 for inputting a user's inherent number or, as shown in FIG. 7, a user card reader unit 162 which reads a user card belonging to a user for thereby recognizing a user.

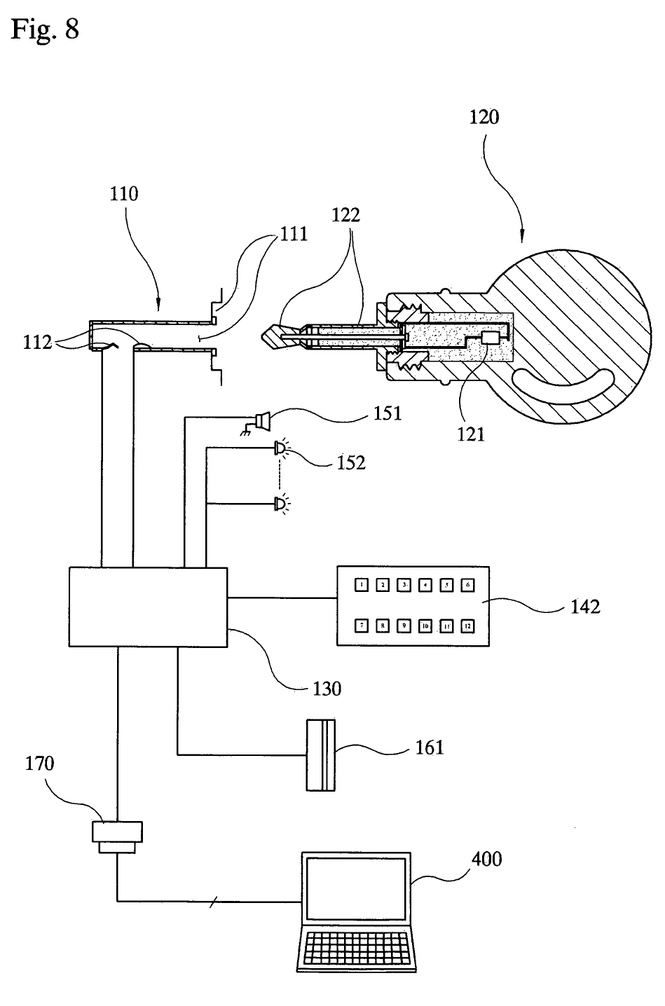

As shown in FIG. 8, a data communication unit 170 is provided for transmitting a key return/discharge information of a corresponding user stored in the user data unit 131 to a terminal 400.

The operations of the present invention will be described with reference to the accompanying drawings.

In a key storage casing formed of a storage casing 210 for storing and arranging keys in the same, there is provided a key storage casing having a key recognition function which comprises at least two key insertion arrangement units 110 provided in the storage casing 210 with an insertion member 120 being provided in the key; and an impedance recognition unit which is constructed to recognize whether a key inserted into and arranged in the key insertion arrangement unit 110 is a corresponding key or not.

With the above construction, a user can insert the insertion member 120, which is coupled with a key when it is needed to store the key by returning the same, into the key insertion arrangement unit 110.

In this state, the impedance connection unit 112 provided in the key insertion arrangement unit 110 contacts with the impedance connection unit 122 of the inserted key insertion arrangement unit.

When the impedance connection unit 122 contacts with the impedance connection unit 112, a controller reads an impedance value of the impedance member 121 provided in the insertion arrangement unit 120 through a reading process, and judges whether a corresponding key of the key insertion arrangement unit 110 is arranged or not, and display a result of the judgment on the display unit, so the user can reliably arranged when arranging the key, and a manager or another user can easily the arranged states of the keys.

According to another embodiment of the present invention, a door 220 may be provided in the storage casing 210 for opening and closing the same. The door 220 may be provided with a locking apparatus 230 and a user recognition unit. With the above construction, the user, who wants to use the key storage casing, can recognize himself to the controller 130 by using a user's inherent number or a user card 310 and can stores the data, which corresponds to the discharged key data or the returned key data, so that the user can reliably manage the information on the key users.

As described above, it is possible to reliably recognize whether a corresponding key is inserted into the key insertion recognition unit or not by providing the key insertion arrangement unit and the impedance recognition unit in the key storage casing, so that a key storing and management, which needs a security, can be effectively performed.

As the present invention may be embodied in several forms without departing from the spirit or essential characteristics thereof, it should also be understood that the above-described examples are not limited by any of the details of the foregoing description, unless otherwise specified, but rather should be construed broadly within its spirit and scope as defined in the appended claims, and therefore all changes and modifications that fall within the meets and bounds of the claims, or equivalences of such meets and bounds are therefore intended to be embraced by the appended claims.

What is claimed is:

1. In a key storage casing formed of a storage casing for storing and arranging keys in the same, a key storage casing having a key recognition function, comprising:
at least two key insertion arrangement units provided in the storage casing with an insertion member being provided in the key; and
an impedance recognition means which is constructed to recognize whether a key inserted into and arranged in the key insertion arrangement unit is a corresponding key or not.

2. The casing of claim 1, wherein said key insertion arrangement unit is provided with a key insertion hole for inserting and arranging the insertion unit, and said impedance recognition unit includes impedance member having different impedances for recognizing keys in each insertion unit, an impedance connection unit which has an insertion and arrangement function in the insertion unit and has a connection unit connected with the impedance body, an impedance connection unit which connects with the impedance member provided in the insertion unit through the impedance connection unit in the key insertion arrangement unit, a controller which reads an impedance value of a key inserted into the key insertion and arrangement unit by reading each impedance connection unit and recognizes whether a corresponding key is inserted or not, and a display means for displaying an arranged state of the key.

3. The casing of claim 2, wherein said impedance body is formed of at least one impedance member among a resistor, a condenser and a coil.

4. The casing of claim 2, wherein said display means is selectively formed of either a key recognition light or a display unit for displaying a key arrangement state in a digital form, which is disposed at one side of the storage casing or in a door provided for opening and closing the storage casing, and a voice guide member is provided for informing a state that a wrong key is inserted into the key insertion arrangement unit in a sound form, and an arrangement confirmation lamp is provided at one side of each key insertion arrangement unit for informing a key arranged state in a light flashing form.

5. The casing of claim 2, wherein a locking apparatus is provided in a door, which is adapted for opening and closing the storage casing, said locking apparatus being constructed to perform a locking function in accordance with an operation of the controller, and a user confirmation means is provided for controlling an operation of the locking apparatus as the controller recognizes a user who discharge the key and a user who returns the key, and a user data unit is provided for storing a key return/discharge information by a user checked through the user confirmation means.

6. The casing of claim 3, wherein a locking apparatus is provided in a door, which is adapted for opening and closing the storage casing, said locking apparatus being constructed to perform a locking function in accordance with an operation of the controller, and a user confirmation means is provided for controlling an operation of the locking apparatus as the controller recognizes a user who discharge the key and a user who returns the key, and a user data unit is provided for storing a key return/discharge information by a user checked through the user confirmation means.

7. The casing of claim 4, wherein a locking apparatus is provided in a door, which is adapted for opening and closing the storage casing, said locking apparatus being constructed to perform a locking function in accordance with an operation of the controller, and a user confirmation means is provided for controlling an operation of the locking apparatus as the controller recognizes a user who discharge the key and a user who returns the key, and a user data unit is provided for storing a key return/discharge information by a user checked through the user confirmation means.

8. The casing of claim 5, wherein said user confirmation means is selectively formed of either a user input unit for inputting a user's inherent number, or a user card reader unit which reads a user card belonging to a user for thereby recognizing a user.

9. The casing of claim 4, wherein a data communication unit is provided for transmitting a key return/discharge information of a corresponding user stored in the user data unit to a terminal.
